(19) United States
(12) Patent Application Publication
(10) Pub. No.: US 2014/0006098 A1
(43) Pub. Date: Jan. 2, 2014

(54) METHODS AND SYSTEMS UTILIZING AN ENGAGEMENT CODE

(71) Applicants: Eduardo P. Oliveira, Seattle, WA (US); Bryan K. Ressler, Sammamish, WA (US); Kamal Jain, Bellevue, WA (US)

(72) Inventors: Eduardo P. Oliveira, Seattle, WA (US); Bryan K. Ressler, Sammamish, WA (US); Kamal Jain, Bellevue, WA (US); Schubert Lau, San Jose, CA (US)

(73) Assignee: eBay Inc., San Jose, CA (US)

(21) Appl. No.: 13/538,519

(22) Filed: Jun. 29, 2012

(51) Int. Cl. G06Q 30/02

(52) U.S. Cl. CPC G06Q 30/0201
USPC 705/7.29

(57) ABSTRACT

A system, method, and computer readable medium is provided to track consumer engagement with a product promotion. To begin, the method may receive an engagement notification from a consumer device. The engagement notification may have data representing an engagement code. Further, the engagement code may be associated with a merchant. The method may then update the engagement data associated with the engagement code. The engagement data may have data that tracks a number of times the engagement code has been scanned by consumer devices. The method may then provide, to the consumer device, product data associated with a product code based on the engagement code being associated with the product code. The product code may have been previously assigned to a manufacturer.

### TECHNICAL FIELD

This application relates to data processing. In particular, example embodiments may provide methods and systems for tracking consumer engagement.

### BACKGROUND

Traditionally, merchants sell products and services through physical stores. Generally, a physical store may be a retail space controlled in some way by the merchant where consumers can visit to make an informed purchasing decision. For example, a consumer may visit a clothing retailer to try on a shirt. As another example, a consumer may visit an electronics retailer to talk with a sales representative to discuss the advantages of one camera over another.

To increase sales of a product, many merchants develop marketing campaigns for the product. In store displays and advertisements (as may be presented through a broadcast medium, such as radio, print, Internet, and/or television) are examples of common types of marketing campaigns operated by merchants. To further facilitate sales, merchants operating physical stores may use resources (e.g., time and money) to train and educate their sale representatives on the products or services being sold.

With the increased popularity of the Internet, many purchasers opt to purchase items through online merchants. Online merchants may operate a website that allows consumers to search for and purchase products and services. Such online merchants may support business-to-person and business-to-business commerce.

### BRIEF DESCRIPTION OF THE DRAWINGS

The present invention is illustrated by way of example, and not by way of limitation, in the figures of the accompanying drawings in which:

FIG. 1 is a network diagram depicting an engagement tracking service, according to an example embodiment;

FIG. 2 is a diagram illustrating various relationships involving a product code and an engagement code, according to an example embodiment;

FIG. 3 is a block diagram illustrating example modules and data of the engagement tracking system, according to an example embodiment;

FIG. 4 is a block diagram illustrating a data flow for tracking consumer engagement with an engagement code, according to some embodiments;

FIG. 5 is a diagram showing a method of tracking consumer engagement with a product or service offered for sale by a merchant, consistent with example embodiments;

FIG. 6 is a diagram illustrating a method of registering a merchant with an engagement code, according to an example embodiment;

FIG. 7A is a data structure diagram showing a data structure that can be used to obtain product data on demand, according to an example embodiment;

FIG. 7B is a data structure diagram showing a data structure that can be used to provide product data, according to an example embodiment; and

FIG. 8 shows a diagrammatic representation of machine in the example form of a computer system within which a set of instructions may be executed causing the machine to perform any one or more of the methodologies discussed herein.

### DETAILED DESCRIPTION

Although some embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In one embodiment, a system and method provides a service for tracking consumer engagement with a product promotion provided by a merchant. The term “product promotion,” as used herein, may refer to a presentation of information regarding a product to a potential buyer. In many embodiments, a merchant may display a product promotion in a physical store. For example, a merchant may display a promotional display that provides information about a product to potential consumers. In some cases, a promotional display may allow a consumer to interact (e.g., use, touch, handle) with a sample or demo product. As a further example of a product promotion, a merchant may allow consumers access to the product or its corresponding packaging, as may occur when the consumer has access to products stocked on a consumer accessible shelf. In many cases, the merchant hires sales employees to discuss or otherwise facilitate the sale of the product

Consistent with embodiments described herein, an engagement code may be displayed in connection with the product promotion. As used herein, the term “engagement code” may refer to computer readable data that may be used to associate a product promotion with a given merchant. In some embodiments, and as discussed below, an engagement tracking service may provide an engagement code to the merchant, where, in turn, the merchant may attach the engagement code to a product promotion. Engagement codes may take various forms and representations, such as universal product codes (UPC), radio-frequency identification (RFID) tags, quick response (QR) codes, or any other suitable codes.

Accordingly, consistent with embodiments described herein, an engagement tracking system may track when a consumer is engaged with a product promotion provided by a merchant. By way of example and not limitation, a consumer may visit a physical store operated by a merchant. While at the physical store, the consumer may become engaged with a product promotion, such as a product package or a promotional display. If interested in the product, the consumer may then use a scanning client module operating on a mobile phone to scan an engagement code (e.g., a UPC) attached the product.

In some embodiments, responsive to scanning the engagement code, the scanning client module may obtain product data regarding the product. For example, the engagement tracking service may return, among other things, a product name, product description, and manufacturer data to the scanning client module. Further, in connection with the scanning of the engagement code, the engagement tracking service may obtain tracking data that can be used to associate the consumer with an engagement of the product promotion.

Tracking consumer engagement with a product promotion provided by a merchant may have many practical uses, according to various embodiments. For example, a manufacturer may provide monetary incentives for a merchant to engage consumers through product promotions. In some cases, an incentive may encourage merchants to create promotional displays of a particular product or to educate or otherwise train a sales team on a particular product. Such may be of particular importance in cases where consumers use product promotions provided by a merchant to make decisions on whether to buy a product but do not necessarily buy the product from the merchant. For example, some consumers may visit a physical store to touch and feel a product but may later buy the product through an online merchant.

These and other embodiments are described in greater detail below.

### Platform Architecture

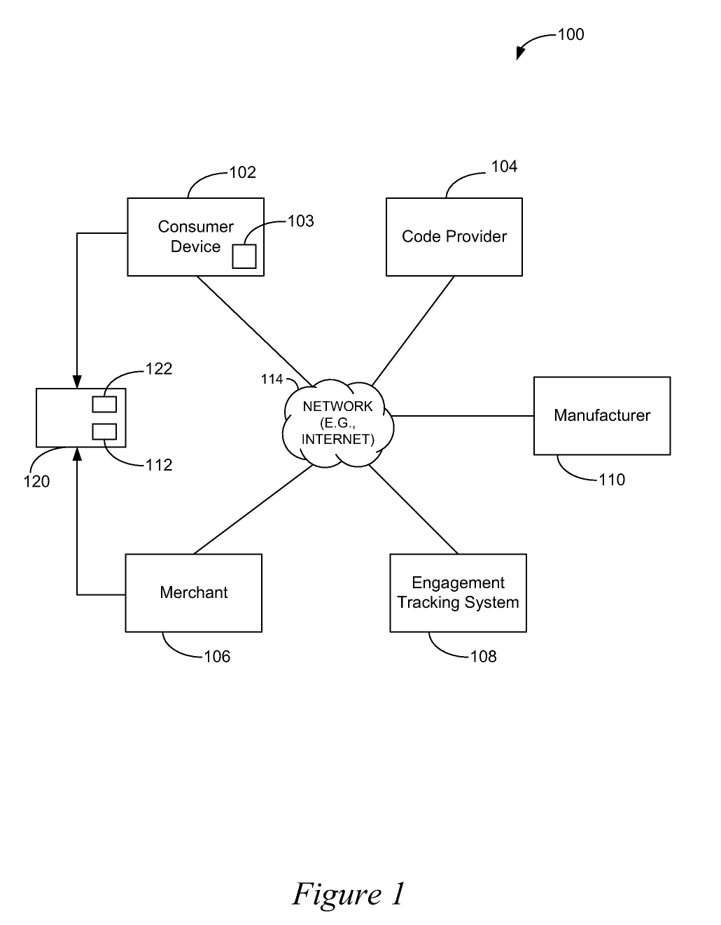

FIG. 1 is a network diagram depicting an engagement tracking service 100, according to an example embodiment. For example, as shown in FIG. 1, the engagement tracking service 100 includes a consumer device 102, a code provider 104, a merchant 106, an engagement tracking system 108, and a manufacturer 110 communicatively coupled via a network 114. In some embodiments the engagement tracking service 100 allows a merchant to track consumer engagement with a product promotion 120 associated with an engagement code 112.

The network 114 may be any suitable network used to communicate data between the components shown in FIG. 1. In various embodiments, one or more portions of the network 114 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The consumer device 102 may be a portable computing device (e.g., a mobile phone, laptop, tablet, camera) that operates a scanning client module 103 that is configured to scan the engagement code 112. In some embodiments, responsive to scanning the engagement code 112, the scanning client module 103 may be configured to obtain product information and then provide the consumer a visual display of the product information. Further, as is explained in greater detail below, the scanning client module 103 may be further configured to send engagement notification messages to the engagement tracking system 108. In some embodiments, a provider of the scanning client module 103 may be obligated (e.g., via a license or contract) to send engagement notification messages to the engagement tracking system 108 when the scanning client module 103 scans the engagement code 112. Such an obligation may be a condition or consideration for having access to the product data, as may be provided by the engagement tracking system 108.

The code provider 104 may be one or more computer systems configured to coordinate the use of codes. As used herein, the term “code” may generally refer to data that uniquely identifies an object, service, or participant in commerce. A code may be represented as a UPC, RFID tags, QR codes, or any other suitable data representation.

In some embodiments, the code provider 104 may coordinate the use of a product code 122 and the engagement code 112. As used herein, the term “product code” may refer to a code that uniquely identifies a product of the manufacturer 110. For example and not limitation, a manufacturer may register with a code provider such as GS1® to obtain a range of UPCs that the manufacturer 110 may use to uniquely identify their products. As part of registering, GS1 may provide the manufacturer with a manufacturer identification number that the manufacturer may use to issue UPCs. For example, the manufacture may issue a UPC based on a unique identifier where a determinable part of the identifier is the manufacturer identification number. The issued UPC may then be associated with one of the manufacturer's products.

Additionally or alternatively, in some embodiments, the code provider 104 may be configured to authorize the engagement tracking system 108 to use engagement codes. As described above, the engagement code 112 may be computer readable data usable to associate a product promotion with a given merchant. In some embodiments, and as discussed below, the engagement tracking system 108 may provide the engagement code 112 to the merchant 106, where, in turn, the merchant 106 may attach the engagement code 112 to the product promotion 120. The engagement code 112 may take various forms and representations, such as UPC, RFID tags, QR codes, or any other suitable codes.

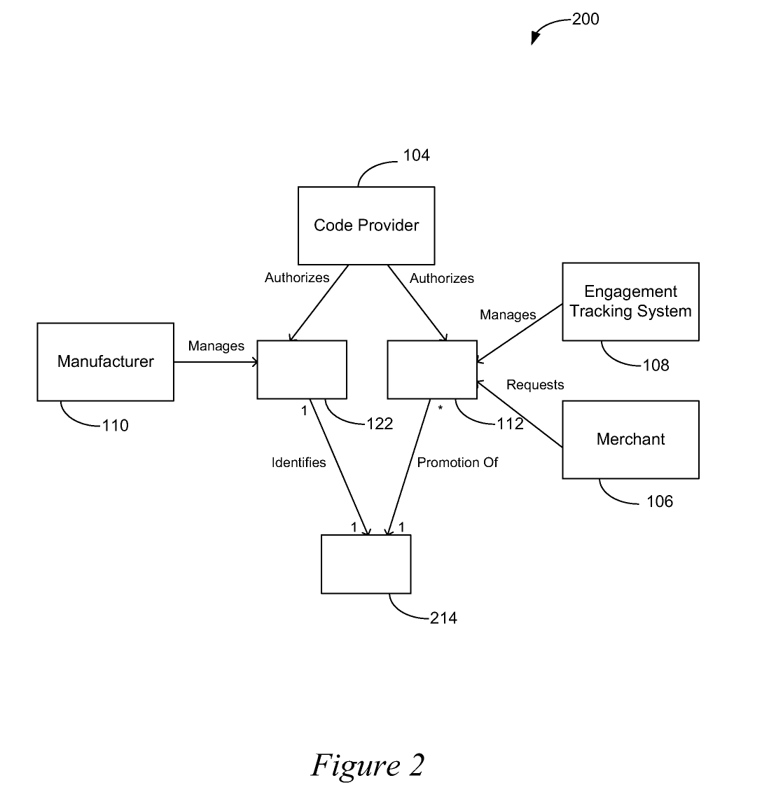

FIG. 2 is a diagram illustrating various relationships involving a product code and an engagement code, according to an example embodiment. For example, FIG. 2 shows relationships involving the code provider 104, the manufacturer 110, the engagement tracking system 108, the merchant 106, the engagement code 112, the product code 122, and a product 214.

As FIG. 2 shows, the product code 122 is a code authorized by the code provider 104 and managed by the manufacturer 110. By way of example and not limitation, and as described above, the code provider 104 may authorize the manufacturer to assign the product code 112 to the product 214 when the code provider 104 provides the manufacturer 110 a company prefix that is to be incorporated in product codes issued by the manufacturer 110. Providing the company prefix to the manufacturer 110 may be part of a registration process between the manufacturer 110 and the code provider 104. After the company prefix is assigned to the manufacturer 110, the manufacturer 110 may issue the product code 122 by combining the company prefix with unique identifiers. This combination of the company prefix and the unique identifier uniquely identifies the product 214 from all other products, even from products manufactured by other manufacturers.

As described above, the product code 122 may be used to uniquely identify the product 214. This is shown, in FIG. 2, as an “identifies” relationship connecting the product code 122 and the product 214. As shown in FIG. 2, the “identifies” relationship is a one to one mapping between the product code 122 and the product 214. That is, in some example embodiments, a single product code (e.g., the product code 122) maps to one and only one product (e.g., the product 214) and, conversely a single product (e.g., the product 214) maps to one and only one product code (e.g., the product code 122).

As shown by FIG. 2, the code provider 104 also coordinates use of the engagement code 112. However, in comparison to the product code 122, the engagement code 112 is issued or otherwise managed by the engagement tracking system 108, not the manufacture 110. The merchant 106 obtains the engagement code 112 by making a request to the engagement tracking system 108. Such requests may include product and merchant data, as will be discussed in further detail below.

As shown in FIG. 2, the engagement code 112 may refer to the product 214 because a product promotion promotes the product 214. The “refers to” relationship between the engagement code 112 and the product 214 is a many to one relationship. To illustrate, multiple engagement codes may refer to the same product 214. Such may be the case where multiple merchants request engagement codes for the product 214.

Returning back to FIG. 1, the manufacturer 110 may be a business organization or individual that manufactures and sells a product through one or more merchants, such as the merchant 106. In some embodiments, the manufacturer 110 may use a product code to uniquely identify the products provided to the merchant 106. For example, the manufacture 110 may coordinate with the code provider 104 to issue unique product codes (e.g., a UPC) that uniquely identify their products.

The merchant 106 may be a business entity or person that sells a product provided by the manufacture 110. In some embodiments, the merchant 106 may sell the product through a physical retail store or through online means, such as an online marketplace, as may be offered by EBAY®. In an example embodiment, the merchant 106 may generate a product promotion 120 to provide information regarding the product being sold. For example the merchant 106 may setup an in-store display advertising the product provided by the manufacturer 110. As an another example, the merchant 106 may stock consumer accessible shelves with the product, so that consumers may physically inspect the product before making the purchase. In such cases where the product promotion involves the physical item for sale, the product promotion may include a product code 122 to uniquely identify the product. As described above, the product code 122 may be issued by the manufacturer, after coordinating with the code provider 104.

The engagement tracking system 108 may be one or more computing systems configured to track consumer engagement with the product promotion 120 provided by the merchant 106. In some embodiments, the engagement tracking system 108 may track consumer engagement with the product promotion 120 using an engagement code 112. For example, in some embodiments, when the scanning client module 103 scans the engagement code 112, the scanning client module 103 may notify the engagement tracking system 108 that the consumer has engaged the product promotion. Based on such an engagement event, the engagement tracking system 108 may then update a record associated with the replacement code 112 to indicate that a consumer was engaged with a product associated with the engagement code 112. As explained in greater detail below, a number of engagement based applications may be provided based on tracking consumer engagement with the product promotion 120.

It is to be appreciated that one or more of the code provider 104, the merchant 106, the manufacturer 110, and the engagement tracking system 108 may each be one or more computer systems operated by different business entities. For example, in an example embodiment, the code provider 104 may be one or more computer systems operated by GS1®, the merchant 106 may be one or more computer systems operated by BestBuy®, the manufacturer 110 may be one or more computer systems operated by LG®, and the engagement tracking system 108 may be one or more computer systems operated by eBay® or X.Commerce® (a division of eBay®). As such, the code provider 104 may coordinate the use of the various codes (the product code 122 and the engagement code 112) between various business entities.

Also, although FIG. 1 illustrates a particular example of the consumer device 102, the scanning client module 103, the code provider 104, the merchant 106, the engagement tracking system 108, the manufacturer 110, the product promotion 120, the product code 122, the engagement code 112, and the network 114, this disclosure includes any suitable arrangement or configuration of the consumer device 102, the scanning client module 103, the code provider 104, the merchant 106, the engagement tracking system 108, the manufacturer 110, the product promotion 120, the product code 122, the engagement code 112, and the network 114.

### Exemplary Modules

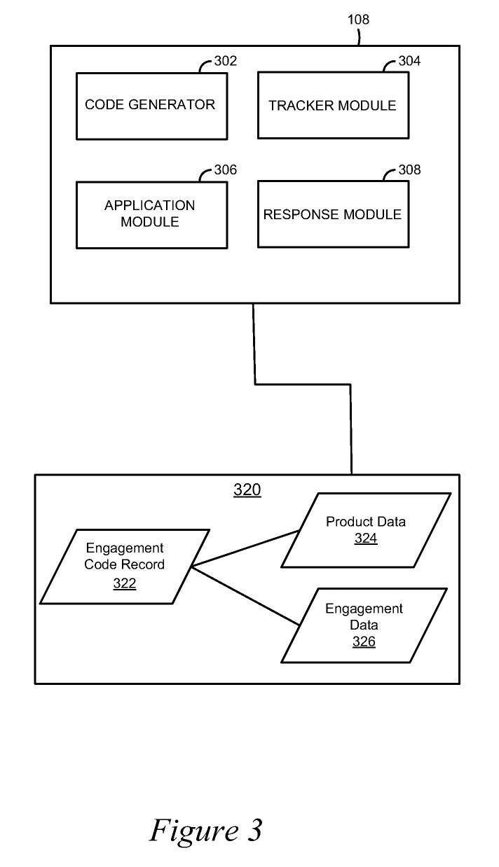

FIG. 3 is a block diagram illustrating example modules and data of the engagement tracking system 108, according to an example embodiment. For example, FIG. 3 shows that the engagement tracking system 108 includes a code generator module 302, a tracking module 304, an application module 306, and a response module 308.

The code generator module 302 may be a computer implemented module that is configured to associate an engagement code (e.g., the engagement code 112 of FIG. 1) with a product promotion maintained by a merchant (e.g., the product promotion 120 of FIG. 1). In some embodiments, the code generator module 302 may maintain a pool of engagement codes obtained through or otherwise coordinated by the code provider 104, for example. In response to a request from a merchant (e.g., the merchant 106 of FIG. 1) for an engagement code, the code generator module 302 may associate an engagement code from the pool of product codes with the product promotion being registered. The associated engagement code may then be communicated back to the merchant 106.

The tracking module 304 may be a computer implemented module that is configured to track user engagement with an engagement code. For example, when a consumer scans the engagement code displayed at a merchant's physical store, for example, the tracking module 304 may be configured to increment an engagement count associated with the product codes associated with the engaged product promotion.

The application module 306 may be a computer implemented module that is configured to provide any number of applications based on the engagement data. For example, the application module 306 may perform a rewards program for merchants that are engaged with the product promotion but then purchase the item via another merchant (e.g., an online merchant). Additionally or alternatively, the application module 306 may provide analytic based reports to the manufacture 110 and/or the merchant 106.

The response module 308 may be a computer implemented module that is configured to respond to an engagement notification message sent by the scanning client module by providing a consumer service. The consumer service may include providing product details, such as a description, consumer reviews, images, similar products, and various purchase interfaces. A purchase interface may connect the consumer with other merchants that are offering the product associated with the product promotion. In some embodiments, the consumer may then make a purchase from one of the other merchants.

With continued reference to FIG. 3, the engagement tracking system 108 may be communicatively coupled to a database 320 to access various data. For example, FIG. 3 shows the database 320 as storing data relating to an engagement code record 322, product data 324, and engagement data 326. The engagement code record 322 may be a data record associated with an engagement code issued to a merchant, such as the engagement code 122. In some embodiments, one or more engagement code records may be searched using the engagement code.

The product data 324 may be any suitable data that characterizes the product being promoted by the production promotion. In some embodiments, the product data 324 may include a product code, a product name, a price, a manufacturer, a product review, identification information specifying merchants selling the product, and combinations thereof. In some embodiments, portions of the product data 324 may be retrieved in substantially real-time. For example, where the product data 324 include a product code, the product code may be used to access other data from various data sources, such as a third-party product database or an online merchant.

The engagement data 326 may be any suitable data that characterizes a consumer engagement with the product being promoted by the production promotion. In some embodiments, the engagement data 326 may include an engagement counter that represents a number of consumers that have engaged with an engagement code associated with a product promotion. Additionally or alternatively, the engagement data 326 may include other data such as a consumer identifier, a location, a time, a product promotion review, and other similar data. The engagement data 326, according to an example embodiment, may be organized per engagement.

It is to be appreciated that, in other embodiments, the inventory exchange 108 may include fewer, more, or different modules apart from those shown in FIG. 3. For example, in an alternate embodiment, any one of the code generator module 302, the tracking module 304, the application module 306, and the response module 308 may be combined into a single module. In another embodiment, the code generator module 302, the tracking module 304, the application module 306, and the response module 308 may be separate from and executed or processed in parallel with each other.

### Exemplary Data Flow

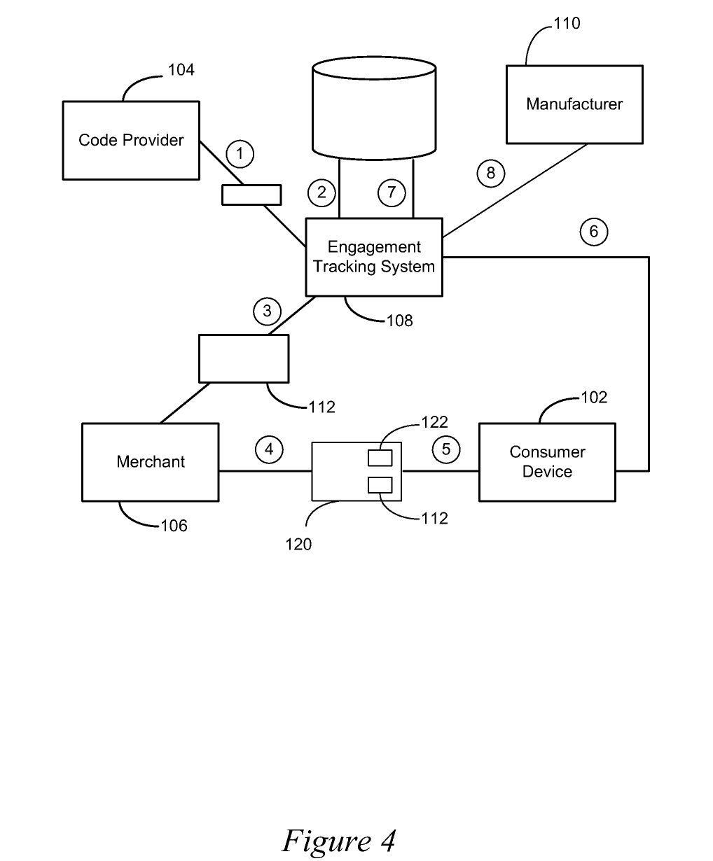

FIG. 4 is a block diagram illustrating a data flow 400 for tracking consumer engagement with an engagement code, according to some embodiments. The data flow 400 may begin (see message 1) when the code provider 104 provides an engagement code 112 to the engagement tracking system 108. In some embodiments, the engagement code 112 may be sent to the engagement system 108 as part of a range of engagement codes reserved for the use by the engagement tracking system 108. In other embodiments, the engagement code 112 may be sent to the engagement tracking system 108 on demand, in response to particular requests for an engagement code for a particular product promotion. By way of example and not limitation, the code provider 104 (e.g., GS1®) may provide the engagement code 112 to the engagement tracking system in the form capable of being represented as a UPC, or any other code.

It is to be appreciated that when the engagement code 112 is sent to the engagement tracking system 108 via message 1, the engagement code 112 is not yet associated with an existing product or manufacturer.

The engagement tracking system 108 may then store the engagement code in the database 320. This is shown as message 2. Message 2 may be part of a method for storing the engagement code 112 in a pool of available engagement codes. For example, in an example embodiment, when the engagement tracking system 108 receives the engagement code 112, the engagement tracking system 108 may create the engagement code record 322 shown in FIG. 3. To specify that the engagement code is available for assignment, the engagement code record 322 may have a field that indicates whether it has been assigned or not. In other embodiments, an engagement code that is not associated with valid product data indicates that the engagement code is available for assignment.

Once the engagement tracking system 108 stores the engagement code 112, the engagement tracking system 108 may then communicate the engagement code 112 to the merchant 106. This is shown as message 3. In an example embodiment, message 3 may be part of a method for registering or otherwise associating the engagement code 112 with a product promotion being operated by the merchant 106. Registering or otherwise associating the engagement code 112 with the product promotion may involve the engagement tracking system 108 obtaining product data from the merchant and associating the product data with the engagement code 112.

The merchant 106 may then affix the engagement code 112 to the registered product promotion 120. This is shown as message 4. In an example embodiment, message 4 may involves printing out a copy of the engagement code 112 and then displaying the printed copy with the product promotion 120. As an example, the merchant 106 may print the engagement code, in the form of a UPC, on a sticker that is then attached a product display or the packaging of the product. In some embodiments, the engagement code 112 is displayed in conjunction with the product code 122. In other embodiments, the engagement code 112 replaces the product code 122. For example, where the merchant 106 provides in-store displays of the product, along with their packaging, the merchant 106 may place the sticker of the engagement code 112 over the product code 122 printed on the packaging of the products. Accordingly, in some embodiments, the engagement code 112 may replace or otherwise remap the product code 122 for the products that are offered for sale by the merchant 106. In embodiments where the merchant places a sticker of the engagement code 112 over the product code 122, the engagement code 112 may be thought as remapping the product code 122 into the engagement code 112. Such remapping may cause the scanning client modules (e.g., the scanning client module 103 of FIG. 1) to communicate with the engagement tracking system 108 in order to obtain product data. Such may be the case because third-parties that map product data to codes typically rely on product codes issued by the manufacturer and these third-parties may not have access to the mappings between the engagement code and the product data or the engagement code to the product code.

Once the engagement code 112 is a fixed or otherwise attached to the registered product promotion 120, a consumer using the consumer device 102 may then scan the displayed engagement code 112. This is shown as message 5. In an example embodiment, the scanning client module 103 may transform a visual image of the engagement code 112 into a sequence of characters, digits, symbols, or combinations thereof that represents the engagement code 112. The engagement code 112 obtained by the scanning client 103 is then communicated to the engagement tracking system 108 as part of an engagement notification message. The engagement notification message is shown as message 6.

Responsive to receiving the engagement notification (message 6), the engagement tracking system 108 may then update the engagement data 206 of FIG. 3. Updating the engagement data 206 is shown as message 7 in FIG. 4. In some embodiments, updating the engagement data 206 may involve incrementing an engagement counter associated with the engagement code 112. Further, some embodiments may also track other data such as a consumer time, location, a client module identifier, a consumer identifier, or some combination thereof, as described above with reference to FIG. 2. In some embodiments, in response to the engagement notification (message 6), the engagement tracking system 108 may return product data 204 to the scanning client module 103. Returning the product data 204 may provide an incentive for the consumer to scan the engagement code.

After the engagement data 206 has been updated, the engagement tracking system 108 may send an engagement report to the manufacturer 110 or, although not shown, to the merchant 106. The engagement report is shown as message 8. The engagement report may include various data such as statistics representing consumer engagement generated by the merchant 106. It is to be appreciated such data may be provided according to various levels of detail for example in one embodiment, the engagement report may include a number of consumers engaged by the product promotion 120 (e.g., as may be maintained by the engagement counter). In other embodiments, the engagement report may include a breakdown of the consumer identifiers involved in each engagement with the product promotion 120.

### Exemplary Methods

According to example embodiments, the engagement tracking system 108 shown in FIG. 1 may be configured to track consumer engagement with a product promotion provided by a merchant. In some embodiments, as described above, the consumer engagement may result in a purchase of the product with a merchant different than the merchant that provided the consumer engagement.

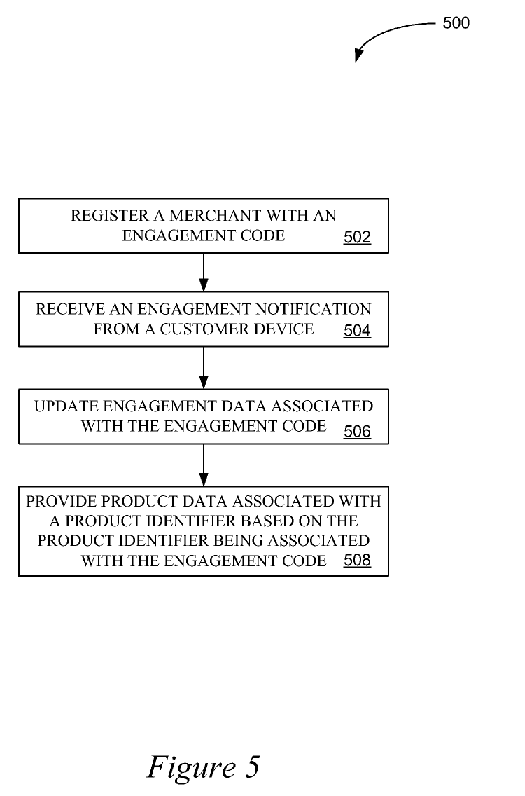

FIG. 5 is a diagram showing a method 500 of tracking consumer engagement with a product or service offered for sale by a merchant, consistent with example embodiments. The method 500 may be performed by one or more components shown in FIGS. 1 and 3, such as the consumer device 102, the code provider 104, the merchant 106, the engagement tracking system 108, or the manufacturer 110.

The method 500 may begin at operation 502 when the code generator 302 registers the product promotion 120 operated by the merchant 106. In an example embodiment, operation 502 may involve the code generator 302 sending the engagement code 112 to the merchant 106, where the engagement code 112 is has a value that has been previously authorized by the code provider 104. The operations involved in registering a product promotion are described in greater detail, with respect to FIG. 5.

At operation 504, the method 500 may then receive an engagement notification message from a consumer device (e.g., the consumer device 102). In an example embodiment, operation 504 may involve the tracking module 304 receiving the engagement notification message from the scanning client module 103 operating on the consumer device 102. The engagement notification message may include data derived from the engagement code 112, time, location, a client module identifier, a consumer identifier, or some combination thereof.

At operation 506, the method 500 may then update engagement data associated with the engagement code. As explained above, the engagement data may include an engagement counter that tracks a number of times the first product code has been scanned by a scanning client module, such as the scanning client module 103 operating on the consumer device 102. Accordingly, in some embodiments, operation 506 may involve the tracking module 304 incrementing the engagement counter associated with the product identifier. In some embodiments, updating the engagement data may include updating contextual data relating the engagement of the consumer with the product, such as a time, location, a client module identifier, a consumer identifier, or some combination thereof. In such embodiments, the engagement notification message received at operation 502 may include such contextual data. The tracking module 304 may then update the engagement data with the contextual data in the engagement notification message received at operation 502.

At operation 508, the method 500 may then provide product data associated with a second product code to the scanning client module 103 operating on the consumer device 102. In some embodiments, operation 508 is performed based on the product code being associated with the engagement code. The second product code may have been previously assigned to a manufacturer (see operation 502 and FIG. 5). In other embodiments, the product data 204 may include product information (e.g., a product name, image, specification, link, or the like). The response module 308 may perform operation 508.

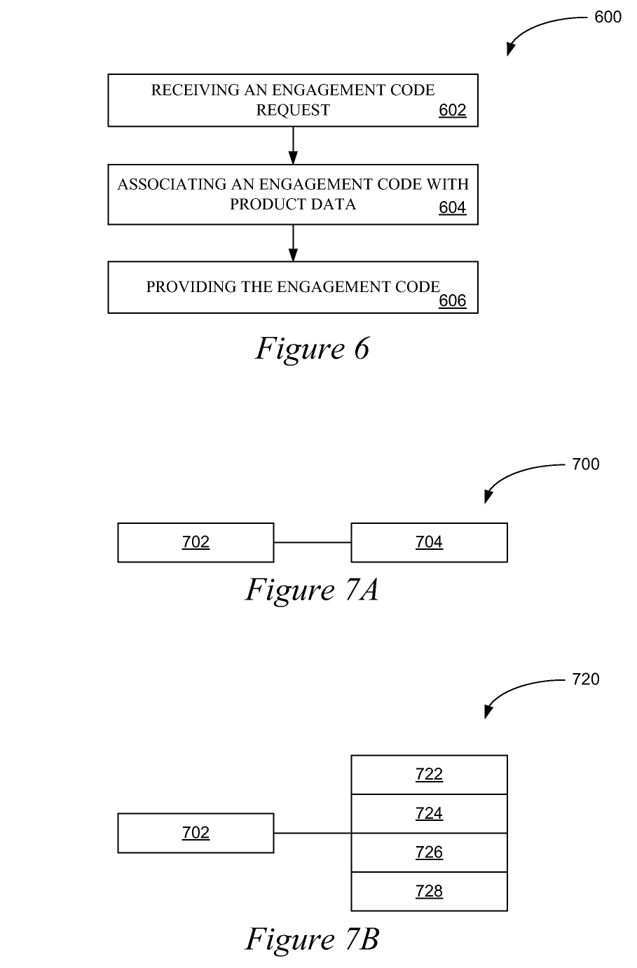

FIG. 6 is a diagram illustrating a method 600 of registering a merchant with an engagement code, according to an example embodiment. The method 600 may illustrate, for some embodiments, operation 502 of FIG. 5 in greater detail.

The method 600 may begin when the code generator module 302 receives an engagement code request. For example, by way of example and not limitation, the merchant 106 of FIG. 1 may connect to a registration portal provided by the code generator module 302. The registration portal may provide one or more user interface elements such as web pages, electronic forms, and the like to allow the merchant to specify that an engagement code is being requested. In some embodiments, the registration portal may request the merchant to fill out information relating to the merchant or the product. For example, the portal may have fields where the merchant may specify a product code previously associated with a product produced by a manufacturer. In other embodiments, additionally or alternatively, the portal may have fields where the merchant may specify a product name, location associated with the offering for sale (a physical location or a virtual location), an image, a description, a price, or any other suitable product data.

At operation 604, the code generator module 302 may associate an engagement code with the product data. In some embodiments, operation 604 may associate the engagement code with the product code based on the product data received through a registration form (e.g., see operation 602, described above). For example, the code generator module 302 may associate an unregistered engagement code with a product code submitted by the merchant 108. Later, for example, during operation 508, the product data such as a product name, description, image, and the like may be retrieved on demand by providing a product database with the product code.

FIG. 7A is a data structure diagram showing a data structure 700 that can be used to obtain product data on demand, according to an example embodiment. For example, the data structure 700 includes an engagement code 702 associated with a product code 704. The engagement code 702 may be a code previously obtained from the code provider 104 of FIG. 1. The product code 704 may be a product code (e.g., UPC) submitted by the merchant requesting the engagement code. The product code 704 may have been previously provided by the code provider 104 to the manufacturer 110 to uniquely identify a particular product. As explained in greater detail below, once the engagement code 702 and the product data 704 are associated, the response module 308 may later send the product code 704 to a product database to request additional product data.

Additionally or alternatively, the product data maintained by the engagement tracking system 108 may include fields other than a product code, according to some embodiments. For example, FIG. 7B is a data structure diagram showing a data structure 720 that can be used to provide product data, according to an example embodiment. For example, the data structure 720, as shown in FIG. 7B, may associate the engagement code 702 with multiple fields such as a product name 722, product description 724, a manufacturer 726, alternative merchants 728 and the like. Such fields may be populated based on data submitted by the merchant as part of operation 702. Further, alternatively or additionally, such fields may be populated by data returned from a product database in response to a request for product data. For example, the code generator module 302 may send a product data request to a product database, where the product data request includes a product code provided by the merchant 104.

Returning back to FIG. 6, after associating the engagement code with product data, the method 600 may then provide the engagement code to the merchant 106. This is shown as operation 606. As an illustration of operation 606, the code generator module 302 may provide an interface that allows the merchant to generate the engagement code. The engagement code may then be attached to a product promotion. For example, the interface may allow the merchant to print out a barcode or QR code representing the engagement code. The barcode or QR code may then be affixed to a product display, where interested consumers may scan the barcode or QR code using their mobile devices.

It is to be appreciated that tracking consumer engagement may have a number of practical applications. For example, with reference to FIG. 3, the applications module 306 may operate a rewards program between merchants and manufactures. In some embodiments, the engagement tracking system 108 (via the application module 306) may facilitate the rewards program by providing monetary incentives for a particular merchant when a consumer scans an engagement code issued to that merchant. In yet other embodiments, the engagement tracking system 108 (via the application module 306) may facilitate the rewards program by providing a monetary incentives for a particular merchant when a consumer scans the engagement code issued to that merchant and then ultimately purchases the product from a different merchant. To track whether a consumer ultimately purchases the product from a different merchant, the scanning client module 103 and/or the tracking module 304 may associate purchase data with the engagement notification (e.g., where a consumer identifier matches a consumer identifier present in an engagement notification and a consumer identifier present in a purchase request).

Such a rewards program encourages merchants to promote, advertise, and otherwise provide information to consumer regarding products from the manufacturer.

In other embodiments, applications module 306 may generate consumer analytics. For example, the applications module 306 may generate consumer analytics that summarize the demographics of the consumers that were engaged with the product, a conversion rate between engagement and purchase, timing data, location data, and the like.

Exemplary Computer Systems

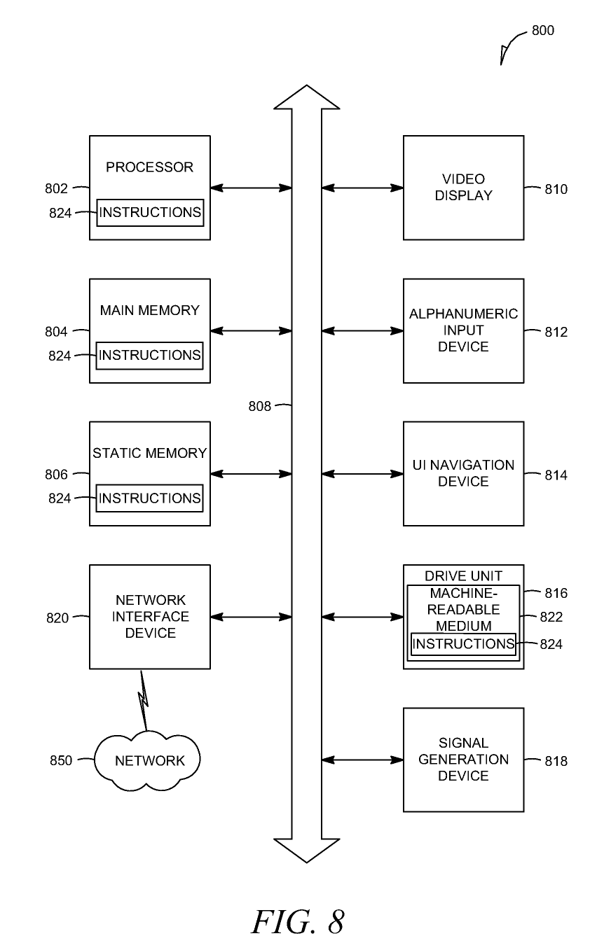

FIG. 8 shows a diagrammatic representation of machine in the example form of a computer system 800 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 900) or one or more hardware modules of a computer system (e.g., a processor 902 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 902 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 902 configured using software, the processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 902 that are temporarily configured (e.g., by software, code, and/or instructions stored in a machine-readable medium) or permanently configured to perform the relevant operations. Whether temporarily or permanently configured, such processors 902 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 902 or processor-implemented (or computer-implemented) modules. Similarly, at least some of the operations of a method may be governed by instructions that are stored in a computer readable storage medium and executed by one or more processors 902 or processor-implemented (or computer-implemented) modules. The performance of certain of the operations may be distributed among the one or more processors 902, not only residing within a single machine, but deployed across a number of machines. In some example embodiments, the processors 902 may be located in a single location (e.g., within a home environment, an office environment or as a server farm), while in other embodiments the processors 902 may be distributed across a number of locations.

While the embodiment(s) is (are) described with reference to various implementations and exploitations, it will be understood that these embodiments are illustrative and that the scope of the embodiment(s) is not limited to them. In general, the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A computer-implemented method comprising:
receiving an engagement notification from a consumer device, the engagement notification having data representing an engagement code, the engagement code being associated with a merchant;
updating engagement data associated with the engagement code, the engagement data having data that tracks a number of times the engagement code has been scanned by consumer devices; and
providing, to the consumer device, product data associated with a product code based on the engagement code being associated with the product code, the product code having been assigned to a manufacturer.

2. The computer-implemented method of claim 1, further comprising, prior to receiving the engagement notification from the consumer device:
receiving an engagement code request from the merchant, the engagement code request having the product data;
associating the engagement code with the product data; and
providing the engagement code to the merchant.

3. The computer-implemented method of claim 1, wherein the product data includes the product code.

4. The computer-implemented method of claim 1, wherein the product data includes at least one a product name, a location, an image, a description, or a price.

5. The computer-implemented method of claim 1, wherein the engagement data further includes at least one of a time, a location, a client module identifier, or a consumer identifier.

6. The computer-implemented method of claim 1, further comprising associating the engagement data with purchase data relating to a purchase of a product characterized by the product data, the purchase of the product occurring after receiving the engagement notification.

7. The computer-implemented method of claim 6, wherein the purchase data indicating that the purchase involves a seller different from the merchant.

8. The computer-implemented method of claim 7, further comprising rewarding the merchant based at least in part on receiving the engagement data.

9. The computer-implemented method of claim 1, wherein usage of the engagement code and the product code is coordinated by a code provider, the code provider being one or more computer systems maintained by a business entity that is different from one or more business entities operating computer systems associated with the merchant and the manufacturer.

10. The computer-implemented method of claim 1, further comprising:
receiving an additional engagement notification from the consumer device, the additional engagement notification having data representing an additional engagement code, the additional engagement code being associated with an additional merchant;
updating additional engagement data associated with the additional engagement code, the additional engagement data having data that tracks a number of times the additional engagement code has been scanned by the consumer devices; and
providing, to the consumer device, the product data associated with the product code based on the additional engagement code being associated with the product code.

11. A computer system comprising:
at least one processor;
a tracking module implemented by the at least one processor and configured to:
receive an engagement notification from a consumer device, the engagement notification having data representing an engagement code, the engagement code being associated with a merchant,
update engagement data associated with the engagement code, the engagement data having data that tracks a number of times the engagement code has been scanned by consumer devices; and
a response module implemented by the at least one processor and configured to provide, to the consumer device, product data associated with a product code based on the engagement code being associated with the product code, the product code having been assigned to a manufacturer.

12. The computer system of claim 11, further comprising a response module implemented by the at least one processor and configured to, prior to receiving the engagement notification from the consumer device:
receive an engagement code request from the merchant, the engagement code request having the product data;
associate the engagement code with the product data; and
provide the engagement code to the merchant.

13. The computer system of claim 11, wherein the product data includes the product code.

14. The computer system of claim 11, wherein the product data includes at least one a product name, a location, an image, a description, or a price.

15. The computer system of claim 11, wherein the engagement data further includes at least one of a time, a location, a client module identifier, or a consumer identifier.

16. The computer system of claim 11, wherein the tracking module being further configured to associate the engagement data with purchase data relating to a purchase of a product characterized by the product data, the purchase of the product occurring after receiving the engagement notification.

17. The computer system of claim 16, wherein the purchase data indicating that the purchase involves a seller different from the merchant.

18. The computer system of claim 17, further comprising an applications module implemented by the at least one processor and configured to reward the merchant based at least in part on receiving the engagement data.

19. The computer system of claim 11, wherein usage of the engagement code and the product code is coordinated by a code provider, the code provider being one or more computer systems maintained by a business entity that is different from one or more business entities operating computer systems associated with the merchant and the manufacturer.

20. A computer-readable storage medium storing at least one program that, when executed by at least one processor, causes the at least one processor to perform operations comprising:
receiving an engagement notification from a consumer device, the engagement notification having data representing an engagement code, the engagement code being associated with a merchant;
updating engagement data associated with the engagement code, the engagement data having data that tracks a number of times the engagement code has been scanned by consumer devices; and
providing, to the consumer device, product data associated with a product code based on the engagement code being associated with the product code, the product code having been assigned to a manufacturer.
